(19) United States
(12) Patent Application Publication
(10) Pub. No.: US 2006/0161923 A1
(43) Pub. Date: Jul. 20, 2006

(54) Task management in a data processing environment having multiple hardware entities

(75) Inventors: Sangram S. Ghoman, Tucson, AZ (US); James C. Chen, Tucson, AZ (US); Kevin L. Gibble, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 11/039,311

(22) Filed: Jan. 20, 2005

(51) Int. Cl. G06F 9/46

(52) U.S. Cl. 718/103

(57) ABSTRACT

A method of task management in a data processing system having a first hardware entity and a second hardware entity, the first and second hardware entities having dissimilar functional capabilities. The method includes providing a task for processing, queuing the task in a priority task queue associated with both the first hardware entity and the second hardware entity, and associating a context designation with the task. In addition, the method includes specifying the minimum hardware entity functional capability necessary to process the task, selecting which one of the hardware entities shall process the task, and submitting the task to the selected hardware entity for processing. The critical step of selecting which one of the first or second hardware entities shall process the task may be accomplished by determining one or more of the following parameters: which of the first hardware entity and the second hardware entity has a minimum functional capability necessary to process the task; which of the hardware entities is associated with a related task; or which of the hardware entities has resources available for processing the task.

### TECHNICAL FIELD

The present invention is directed toward a method, apparatus and article of manufacture for task management in a data processing environment featuring multiple hardware entities. In particular, the present invention is directed to task management where multiple hardware entities have differing functional capabilities.

### BACKGROUND ART

In many data processing environments, specific tasks can be submitted to one of multiple hardware entities for processing. “Hardware entity” as used herein can mean any level of component in a data processing system, which component has the capability to process a task. A hardware entity may be a portion of an integrated logic circuit or a computer processor chip. Multiple hardware entities may exist on a computer board or card. For example, a direct memory access (DMA) chip on a data storage controller board may have several hardware entities capable of performing similar tasks. Alternatively, a hardware entity could be a stand alone device with more complex functionality such as a storage controller communicating with other elements of a storage system such as disk based storage devices and servers.

Prior to the point in time when tasks are submitted to a hardware entity, it may be necessary to have a priority task queue holding the tasks awaiting processing. Typically, tasks are assigned a priority designation. Tasks with higher priority are given preference over lower priority tasks in the priority task queue.

In a system where multiple hardware entities are available to process a given task, certain problems can arise. The multiple hardware entity situation can be addressed by the implementation of multiple priority task queues. According to one technique, one set of priority task queues may be established for each set of hardware entities having the same level of functional capabilities. However, in such an implementation, the selection of which hardware entity will process a specific task is made at the time the task is queued, and not when the task is submitted to a hardware entity for processing. Another hardware entity may be available or underutilized while a task is waiting to be processed on a queue for the selected hardware entity. In addition, a multiple task queue implementation may result in increased system overhead resulting from the necessity of managing the multiple task queues.

The present invention is directed toward solving one or more of the problems discussed above.

### SUMMARY OF THE INVENTION

The need in the art is met by a method of task management in a data processing system having a first hardware entity and a second hardware entity, the first and second hardware entities having dissimilar functional capabilities. The method includes providing a task for processing, queuing the task in a priority task queue associated with both the first hardware entity and the second hardware entity, and associating a context designation with the task. In addition, the method includes specifying the minimum hardware entity functional capability necessary to process the task, selecting which one of the hardware entities shall process the task, and submitting the task to the selected hardware entity for processing. The critical step of selecting which one of the first or second hardware entities shall process the task may be accomplished by determining one or more of the following parameters: which of the first hardware entity and the second hardware entity has a minimum functional capability necessary to process the task; which of the hardware entities is associated with a related task; or which of the hardware entities has resources available for processing the task.

Typically, multiple tasks will be presented for processing and will be maintained in the priority task queue. In such a case, the same context designation may be associated with all tasks which are related. Related tasks include those which must be processed in a particular order or those which otherwise must be processed by the same hardware entity to avoid processing errors.

The method may further include indicating that the context associated with a select task is active on the hardware entity processing that task. A context table may be maintained for this purpose, the context table being associated with a hardware entity or the priority task queue.

The present invention further includes a data processing system capable of carrying out the above described steps and an article of manufacture for use in programming a data processing system to manage tasks as described above.

### BRIEF DESCRIPTION OF THE DRAWINGS

FIG. 1 is a block diagram of a data processing system in which aspects of the present invention may be implemented;

FIG. 2 is a block diagram representation of a generic data processing task;

FIG. 3 is a flowchart illustrating logic in accordance with certain described implementations of the present invention;

FIG. 4 is a flowchart illustrating logic in accordance with certain described implementations of the present invention;

FIG. 5 is a flowchart illustrating logic in accordance with certain described implementations of the present invention; and

FIG. 6 is a flowchart illustrating logic in accordance with certain described implementations of the present invention.

### DETAILED DESCRIPTION OF THE PREFERRED EMBODIMENT

In the following description, reference is made to the accompanying drawings which form a part hereof and which illustrate several implementations of the present invention. It is understood that other implementations may be utilized and structural and operational changes may be made without departing from the scope of the present invention.

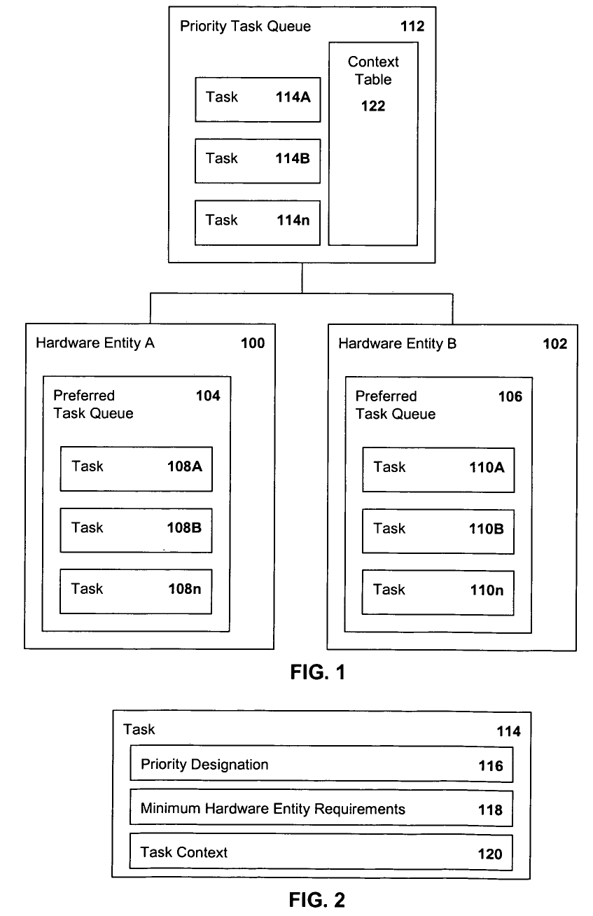

FIG. 1 illustrates a data processing system utilizing two hardware entities: hardware entity A 100 and hardware entity B 102. Each hardware entity 100, 102 is a component of a data processing system designed to perform at least one function. A hardware entity 100, 102 can be a portion of an integrated logic circuit, a computer chip or different chips on a hardware card. Alternatively, a hardware entity 100, 102 can be a complex processor, computer or server in a data processing system. Although described herein with respect to a simplified embodiment featuring two hardware entities 100, 102 of differing functional capabilities, the present invention typically will be implemented in a data processing system involving more than two hardware entities with various differing functional capabilities. The description of an embodiment featuring two hardware entities is employed merely to simplify the following technical description and is not intended to limit the scope of the invention.

Each hardware entity 100, 102 will be associated with a preferred task queue 104, 106 as shown in FIG. 1. Pending tasks which have been assigned to a specific hardware entity, such as hardware entity A 100, for processing are maintained in the preferred task queue of the given hardware entity. In FIG. 1, the individual pending tasks assigned to each hardware entity for processing are shown in block diagram form as 108A, 108B . . . 108n and 110A, 110B . . . 110n.

In addition, both hardware entities 100, 102 are associated with a single priority task queue 112. The priority task queue 112 contains tasks 114A, 114B . . . 114n which could potentially be processed by either hardware entity A 100 or hardware entity B 102. The tasks 114A, 114B . . . 114n maintained in the priority task queue 112 have not yet been submitted to either hardware entity 100, 102 for processing. Typically, the priority task queue 112 will be maintained in processor memory associated with the hardware entities 100, 102. Typically, the preferred task queues 104, 106 will be maintained in firmware associated with each respective hardware entity 100, 102.

Although the simplified embodiment depicted in FIG. 1 features only one priority task queue 112, the present invention typically will be implemented with a series of priority task queues capable of storing and managing the large volume of tasks typically encountered in a data processing environment. The description of an embodiment featuring one priority task queue is employed merely to simplify the following technical description and is not intended to limit the scope of the invention.

Hardware entity A 100 and hardware entity B 102 have different functional capabilities. “Different functional capabilities” as used herein means that a certain hardware entity (hardware entity A 100 below) is functionally capable of processing a specific set of tasks. The other hardware entity (hardware entity B 102 below) is capable of processing a subset of the tasks which can be processed by hardware entity A 100. Thus, certain tasks may be processed by either hardware entity A 100 or hardware entity B 102. Other tasks must be processed by hardware entity A 100 since hardware entity B 102 lacks the functional capacity for those tasks.

A task will be associated with information concerning the functionality necessary to process the task. In addition, a task will have certain attributes associated with it. As shown in block diagram form on FIG. 2, a specific task 114 may be associated with a priority designation 116. Tasks 114 having higher priority designation 116 may be given preference over lower priority designation 116 tasks 114 when determining the order in which tasks 114 will be assigned to a hardware entity and processed. Typically when a task 114 with a higher priority designation 116 is submitted ahead of a task with a lower priority designation 116, the priority designation 116 of the lower priority task is raised. This technique prevents lower priority tasks from remaining on the priority task queue 112 indefinitely when the system is in a high load state.

In addition, a designation of minimum hardware entity requirements 118 may be associated with a task 114. The minimum hardware entity requirements 118 constitute a description of the minimal functional capabilities a hardware entity 100, 102 must possess in order to effectively process the task 114.

In addition, a task context 120 may be associated with the task 114. The task context 120 is a technique of associating related tasks which preferably will be processed by the same hardware entity. For example, two select tasks 114A and 114B could be related such that the second task 114A will not be processed correctly unless the first task 114B has already completed processing. To assure that the correct processing order is maintained, these two tasks 114A and 114B can be associated with the same task context 120. Assuring that the two related tasks 114A and 114B are processed by the same hardware entity can minimize the risk that the tasks 114A, 114B will be processed out of order.

The present invention is a method, apparatus and article of manufacture to implement task management in an environment where more than one hardware entity 100, 102 is available to process a task 114 and the hardware entities 100, 102 have different functional capabilities. The invention will be described below primarily with respect to the logical steps associated with a data processing method. This description should not be interpreted as limiting the scope of the present invention to methods only. In addition, the method will be described below with respect to a single priority task queue 112 and two hardware entities 100, 102. The described embodiment is simplified from a typical implementation which might involve multiple priority task queues associated with multiple hardware entities of differing functional capabilities. In the description below, hardware entity A 100 has a set of functional capabilities; hardware entity B 102 has a subset of the same functional capabilities. Thus, hardware entity A 100 can process any task submitted to it, but hardware entity B 102 can only process a portion of the total family of possible tasks.

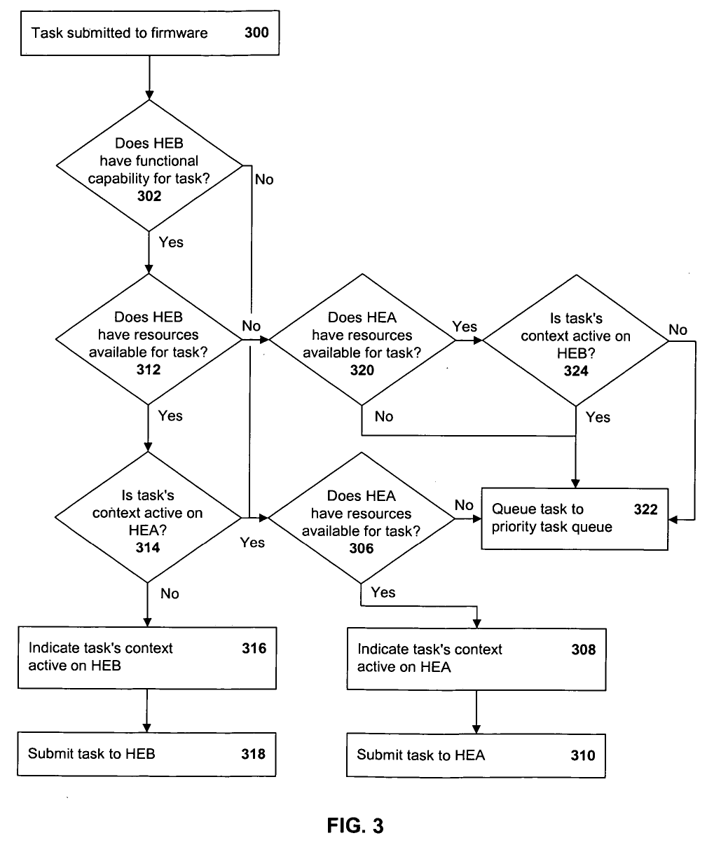

The logic for processing a task 114 is shown in the flowchart representations of FIGS. 3-6. The task management process commences, as shown in FIG. 3, when a task 114 is initially submitted from the priority task queue 112 to firmware (step 300) associated with the hardware entities 100, 102. The minimum hardware entity requirements 118 associated with the task 114 are read to determine whether hardware entity B 102 has the functional capability for processing the task 114 (step 302). If it is determined that hardware entity B 102 does not have the functional capability for processing the task 114, the task 114 must be processed by hardware entity A 100 in step 302, a determination will be made if hardware entity A 100 has the resources available to process the task (step 306). If hardware entity A 100 has available resources, an indication will be made that the task context 120 is active on hardware entity A 100 (step 308), and the task 114 will be submitted to hardware entity A 100 (step 310).

Alternatively, if it is determined in step 302 that hardware entity B 102 does have the functional capability for processing the task 114, it is then determined whether hardware entity B 102 has resources available to process the task 114 (step 312). This determination is typically an analysis of the workload of hardware entity B 102 at the time of the proposed task 114 submission to determine whether hardware entity B 102 is then engaged with the processing of other tasks which would delay the processing of the task 114 beyond a select acceptable delay time. If it is determined in step 312 that hardware entity B 102 does have resources available for processing the task 114, the proposed task's context 120 is read and compared to a context table 122 maintained with respect to the priority task queue 112 (step 314). As discussed above, processing errors could occur if a task 114 related to a prior task being processed on hardware entity A 100 is then processed on hardware entity B 102. If it is determined that the task context 120 is not active on hardware entity A 100 in step 312, an indication is made in the context table 122 (step 316) and the task 114 is submitted to hardware entity B 102 (step 318) for processing.

Referring back to step 312, it is possible that it was determined that hardware entity B 102 does not have the resources available to process the task 114 in a reasonable time frame. In this case, it is determined whether hardware entity A 100 has resources available for processing the task 114 (step 320). If hardware entity A 100 also does not have resources available for the processing of the task 114, the task 114 will be returned to the priority task queue 112 (step 322). Alternatively, if it is determined that hardware entity A 100 does have resources available for processing the task in step 320, the task context 120 will be compared with the context table 122 to assure that related tasks are not being processed on hardware entity B 102 (step 324). If it is determined that the task context 120 is not active on hardware entity B 102, the context table 122 will be updated to indicate that the task context 120 is active on hardware entity A 100 (step 308) and the task 114 will be submitted to hardware entity A 100 (step 310).

If it is determined in step 312 that hardware entity B 102 has resources available for the task 114, but that the task context 120 is active on hardware entity A 100 (step 314), a further determination will be made whether hardware entity A 100 has resources available for processing the task 114 (step 306). If hardware entity A 100 does not have resources available for processing the task 114 in a reasonable time frame, the task 114 will be returned to the priority task queue 112 (step 322). If, however, hardware entity A 100 does have resources available for processing the task 114, an indication will be made in the context table 122 that the task context 120 is active on hardware entity A 100 (step 308) and the task will be submitted for processing to hardware entity A 100 (step 310).

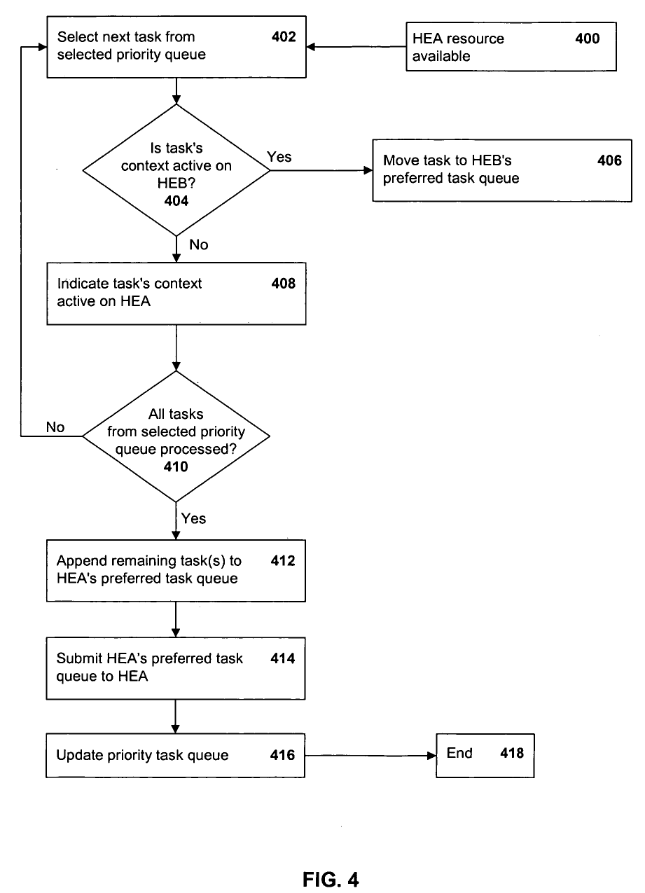

In the process described above with respect to FIG. 3, certain instances are described where neither hardware entity A 100 nor hardware entity B 102 has resources available for processing a given task 114. The logic associated with the task management process when hardware entity A 100 next becomes available after a period of time when both hardware entities 100, 102 are unavailable is depicted in FIG. 4. Upon the occurrence of hardware entity A 100 becoming available (step 400), a priority task queue such as priority task queue 112 is selected for processing (step 402). A task 114 from the selected priority task queue 112 is then selected for processing. The selection of the task 114 may be based upon the task 114 priority designation 116 or other criteria such as the length of time the task 114 has remained on the priority task queue 112. Before the task 114 is submitted to either hardware entity 100, 102, it is determined whether the task context 120 is active on hardware entity B 102 (step 404). This determination is made by comparing the task context 120 with the context table 124 associated with hardware entity B 102. If the task context 120 is active on hardware entity B 102, the task 114 must be moved to the preferred task queue 106 associated with hardware entity B 102 (step 406).

Assuming that it is determined that the task context 120 is not active on hardware entity B 102 in step 404, the task 114 may be submitted to hardware entity A 100 for processing. This may be accomplished by indicating that the task context 120 is active on hardware entity A 100 in the context table 122 (step 408). The above steps 402-408 may be repeated until all tasks from the selected priority queue have been processed (step 410). Next, the tasks processed in this manner may be appended to hardware entity A's 100 preferred task queue 104 (step 412) and the preferred task queue 104 may be submitted to hardware entity A 100 for processing (step 414).

Upon processing of the tasks 114, the priority task queue 112 may be updated to indicate the successful processing of the tasks 114 (step 416). The process for the selected priority task queue 112 may then end (step 418). If all tasks 114 from a selected priority task queue 112 have been processed, the next priority task queue (not shown in FIG. 1) may be selected for processing.

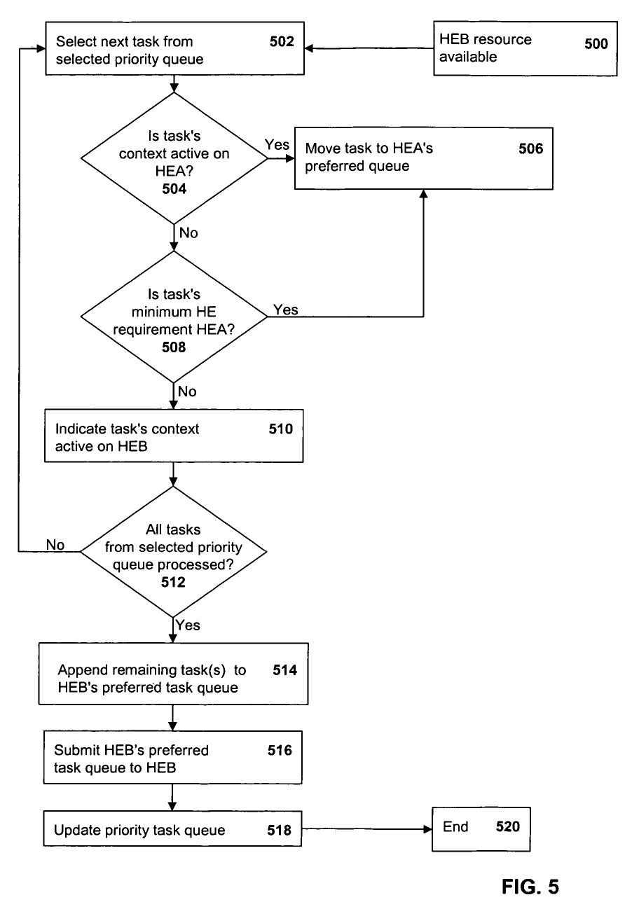

A similar process is followed when hardware entity B 102 becomes available after a period of unavailability. As shown in FIG. 5, upon the return of hardware entity B's 102 availability (step 500), a priority task queue such as priority task queue 112 is selected for processing. A task 114 from the selected priority task queue 112 is then selected for processing (step 502). The selection of the task 114 may be based upon the task 114 priority 116 or other criteria such as the length of time the task 114 has remained on the priority task queue 112. Before the task 114 is submitted to either hardware entity 100, 102, it is determined whether the task context 120 is active on hardware entity A 100 (step 504). This determination is made by comparing the task context 120 with the context table 122. If the task context 120 is active on hardware entity A 100, the task 114 must be moved to the preferred task queue 104 associated with hardware entity A 100 (step 506).

If it is determined in step 504 that the task context 120 is not active on hardware entity A 100, it is then determined whether the task's minimum hardware entity requirements are met by hardware entity B 102. This determination is made by comparing the minimum hardware entity requirements 118 associated with the task 114 with the capabilities of hardware entity B 102. If it is determined that the task 114 must be completed by hardware entity A 100, the task 114 is moved to the preferred task queue 104 associated with hardware entity A 100 (step 506).

If it is determined in step 508 that hardware entity B 102 does have the functional capability to process the task 114, the task 114 may be submitted to hardware entity B 102 for processing. This may be accomplished by indicating that the task context 120 is active on hardware entity B 102 in the context table 122 (step 510). The above steps 502-510 may be repeated until all tasks from the selected priority task queue 112 have been processed (step 512). Next, the tasks processed in this manner may be appended to hardware entity B's 102 preferred task queue 106 (step 514) and the preferred task queue 106 may be submitted to hardware entity B 102 for processing (step 516).

Upon the completion of processing of the tasks 114, the priority task queue 112 may be updated to indicate the successful processing of the task 114 (step 518) and the process with respect to the selected priority task queue 112 may end (step 520). If all tasks 114 from a selected priority task queue 112 have been processed, the next priority task queue (not shown in FIG. 1) may be selected for processing (step 500).

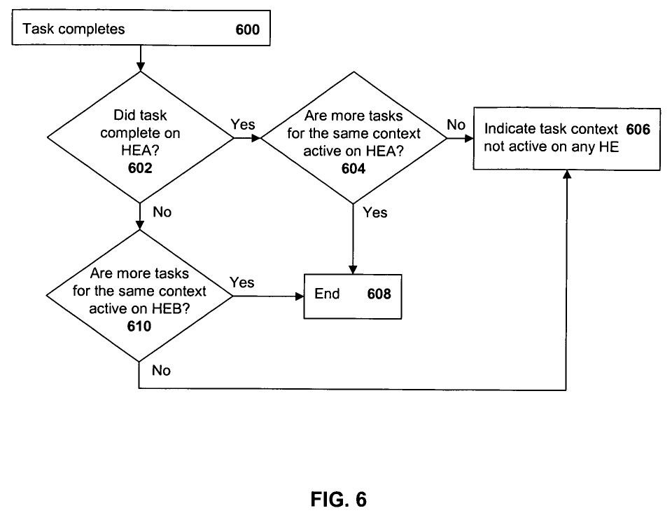

Further steps may be necessary to finalize the task management process upon completion of a given task 114. These steps are shown in FIG. 6. The supplemental processing begins when a task 114 completes (step 600). If the task completed on hardware entity A 100 (step 602), it is determined whether more tasks 114 of the same task context 120 are active on hardware entity A 100 (step 604). If not, an indication may be made in the context tables 122, 124 associated with each hardware entity 100, 102 that the given task context 120 is not active on any hardware entity 100, 102 (step 606). Alternatively, if further tasks 114 for the same task context 120 are active on hardware entity A 100, no further steps will be taken (step 608).

If the task 114 did not complete on hardware entity A 100, a determination is made whether more tasks 114 for the same task context 120 are active on hardware entity B 102 (step 610). If not, an indication will be made in the context tables 122, 124 associated with each hardware entity 100, 102 that the task context 120 is not active on any hardware entity 100, 102 (step 606). Alternatively, if further tasks 114 for the same task context 120 are active on hardware entity B 102, no further steps will be taken (step 608).

The described techniques to manage tasks in a data processing environment having multiple hardware entities may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media such as network transmission line, wireless transmission media, signals propagating through space, radio waves, infrared signals, etc. Of course, those skilled in the art will recognize that many modifications may be made to this configuration without departing from the scope of the implementations and that the article of manufacture may comprise any information bearing medium known in the art.

It is important to note that while the present invention has been described in the context of a fully functioning data processing system, those of ordinary skill in the art will appreciated that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to an apparatus, the need in the art may also be met by a method of task management in a data processing environment having multiple hardware entities, a computer program product containing instructions for task management in a data processing environment having multiple hardware entities, or a method for deploying computing infrastructure comprising integrating computer readable code into a computing system for task management in a data processing environment having multiple hardware entities.

What is claimed is:

1. A method of task management in a data processing system having a first hardware entity and a second hardware entity with the first and second hardware entities having dissimilar functional capabilities, the method comprising:
providing a task for processing;
queuing the task in a priority task queue associated with both the first hardware entity and the second hardware entity;
associating a context designation with the task;
specifying the minimum hardware entity functional capability necessary to process the task;
selecting which one of the first hardware entity and the second hardware entity shall process the task; and
submitting the task to the selected hardware entity for processing.

2. The method of claim 1 wherein the selecting step consists of determining one of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

3. The method of claim 1 wherein the selecting step consists of determining two of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

4. The method of claim 1 wherein the selecting step consists of determining:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

5. The method of claim 1 further comprising:
providing multiple tasks for processing; and
associating the context designation with all tasks which are related.

6. The method of claim 5 further comprising indicating that the context associated with the task is active on the selected hardware entity upon submitting the task to the selected hardware entity for processing.

7. A data processing system comprising:
a first hardware entity;
a second hardware entity with the first and second hardware entities having dissimilar functional capabilities;
a priority task queue able to hold a task prior to processing by one of the first hardware entity and the second hardware entity;
means for associating a context designation with the task;
means for specifying the minimum hardware entity functional capability necessary to process the task;
means for selecting which one of the first hardware entity and the second hardware entity shall process the task; and
means for submitting the task from the priority task queue to the selected hardware entity for processing.

8. The data processing system claim 7 further comprising a preferred task queue associated with one of the first hardware entity and the second hardware entity, the preferred task queue being able to hold a task after submission for processing.

9. The data processing system claim 7 wherein the means for selecting which one of the first hardware entity and the second hardware entity shall process the task consists of means for determining one of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

10. The data processing system claim 7 wherein the means for selecting which one of the first hardware entity and the second hardware entity shall process the task consists of means for determining two of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

11. The data processing system claim 7 wherein the means for selecting which one of the first hardware entity and the second hardware entity shall process the task consists of means for determining:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

12. The data processing system of claim 7 further comprising:
means for providing multiple tasks for processing; and
means for associating the context designation with all tasks which are related.

13. The data processing system of claim 12 further comprising means for indicating that the context associated with the is active on the selected hardware entity upon submitting the select task to the selected hardware entity for processing.

14. The data processing system of claim 13 wherein the means for indicating that the context associated with the task is active comprises a context table associated with one of the first hardware entity, the second hardware entity and the priority task queue.

15. An article of manufacture for use in programming a data processing system to manage tasks, the data processing system having a first hardware entity and a second hardware entity with the first and second hardware entities having dissimilar functional capabilities, the article of manufacture comprising instructions for:
providing a task for processing;
queuing the task in a priority task queue associated with both the first hardware entity and the second hardware entity;
associating a context designation with the task;
specifying the minimum hardware entity functional capability necessary to process the task;
selecting which one of the first hardware entity and the second hardware entity shall process the task; and
submitting the task to the selected hardware entity for processing.

16. The article of manufacture of claim 15 wherein the instructions for selecting which one of the first hardware entity and the second hardware entity shall process the task consists of instructions for causing the system to determine one of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

17. The article of manufacture of claim 15 wherein the instructions for selecting which one of the first hardware entity and the second hardware entity shall process the task consists of instructions for causing the system to determine two of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

18. The article of manufacture of claim 15 wherein the instructions for selecting which one of the first hardware entity and the second hardware entity shall process the task consists of instructions for causing the system to determine one of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

19. The article of manufacture of claim 15 further comprising instructions for:
providing multiple tasks for processing; and
associating the context designation with all tasks which are related.

20. The article of manufacture of claim 19 further comprising instructions for indicating that the context associated with the task is active on the selected hardware entity upon submitting the task to the selected hardware entity for processing.

21. A method for deploying computing infrastructure, comprising integrating computer readable code into a computing system to provide task management in a computing system having a first hardware entity and a second hardware entity with the first and second hardware entities having dissimilar functional capabilities, wherein the code in combination with the computing system is capable of performing the following:
providing a task for processing;
queuing the task in a priority task queue associated with both the first hardware entity and the second hardware entity;
associating a context designation with the task;
specifying the minimum hardware entity functional capability necessary to process the task;
selecting which one of the first hardware entity and the second hardware entity shall process the task; and
submitting the task to the selected hardware entity for processing.

22. The method for deploying a computing infrastructure of claim 21 wherein the selecting step consists of determining one of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

23. The method for deploying a computing infrastructure of claim 21 wherein the selecting step consists of determining two of:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

24. The method for deploying a computing infrastructure of claim 21 wherein the selecting step consists of determining:
which of the first hardware entity and the second hardware entity has a minimum functional capability necessary to process the task;
which of the first hardware entity and the second hardware entity is associated with a related task; and
which of the first hardware entity and the second hardware entity has resources available for processing the task.

25. The method for deploying a computing infrastructure of claim 21 wherein the code in combination with the computing system is further capable of performing the following:
providing multiple tasks for processing; and
associating the context designation with all tasks which are related.

26. The method for deploying a computing infrastructure of claim 25 wherein the code in combination with the computing system is further capable of indicating that the context associated with the task is active on the selected hardware entity upon submitting the task to the selected hardware entity for processing.
